(19) United States
(12) Patent Application Publication
(10) Pub. No.: US 2013/0335460 A1
(43) Pub. Date: Dec. 19, 2013

(54) Method and Apparatus for Controlling the Refresh and Illumination of a Display

(71) Applicants: Jani Edvin Penttila, Lempaala (FI); Juha Harri-Pekka Nurmi, Salo (FI)

(72) Inventors: Jani Edvin Penttila, Lempaala (FI); Juha Harri-Pekka Nurmi, Salo (FI)

(73) Assignee: Nokia Corporation, Espoo (FI)

(21) Appl. No.: 13/980,410

(22) PCT Filed: Jan. 19, 2011
(86) PCT No.: PCT/IB2011/050247

§ 371 Date: Aug. 30, 2013

(51) Int. Cl. G09G 5/10

(52) U.S. Cl. CPC G09G 5/10
USPC 345/690

(57) ABSTRACT

An apparatus, method and computer program are provided. The method includes detecting, at processing circuitry and illumination drive circuitry, at least one synchronization signal provided by display drive circuitry; writing display data to at least one frame memory using the processing circuitry, in dependence upon the at least one synchronization signal detected at the processing circuitry; and controlling at least one illumination source using the illumination drive circuitry, in dependence upon the at least one synchronization signal detected at the illumination drive circuitry

### TECHNOLOGICAL FIELD

Embodiments of the present invention relate to display control. In particular, they relate to controlling the refresh and illumination of an auto-stereoscopic display.

### BACKGROUND

Display drive circuitry may comprise a frame memory and control circuitry. The frame memory stores display data. The control circuitry uses the display data to display an image frame on a display panel.

Processing circuitry, such as a central processing unit, may update the display data stored in the frame memory to enable the image displayed on the display to be updated.

### BRIEF SUMMARY

According to some, but not necessarily all, embodiments of the invention there is provided a method comprising: detecting, at processing circuitry and illumination drive circuitry, at least one synchronization signal provided by display drive circuitry; writing display data to at least one frame memory using the processing circuitry, in dependence upon the at least one synchronization signal detected at the processing circuitry; and controlling at least one illumination source using the illumination drive circuitry, in dependence upon the at least one synchronization signal detected at the illumination drive circuitry.

According to some, but not necessarily all, embodiments of the invention there is provided an apparatus, comprising: processing circuitry configured to detect at least one synchronization signal provided by display drive circuitry, and configured to write display data to at least one frame memory in dependence upon the at least one synchronization signal detected at the processing circuitry; and illumination drive circuitry configured to detect the at least one synchronization signal provided by the display drive circuitry, and configured to control at least one illumination source, in dependence upon the at least one synchronization signal detected at the illumination drive circuitry.

According to some, but not necessarily all, embodiments of the invention there is provided an apparatus, comprising: processing means for detecting at least one synchronization signal provided by display drive means, and for writing display data to at least one frame memory in dependence upon the at least one synchronization signal detected at the processing means; and illumination drive means for detecting the at least one synchronization signal provided by the display drive means, and for controlling at least one illumination source, in dependence upon the at least one synchronization signal detected at the illumination drive means.

According to some, but not necessarily all, embodiments of the invention there is provided a computer program comprising computer program instructions that, when executed by processing circuitry, enable at least the following to be performed: detecting, at the processing circuitry and illumination drive circuitry, at least one synchronization signal provided by display drive circuitry; writing display data to at least one frame memory using the processing circuitry, in dependence upon the at least one synchronization signal detected at the processing circuitry; and controlling at least one illumination source using the illumination drive circuitry, in dependence upon the at least one synchronization signal detected at the illumination drive circuitry.

### BRIEF DESCRIPTION

For a better understanding of various examples of embodiments of the present invention reference will now be made by way of example only to the accompanying drawings in which:

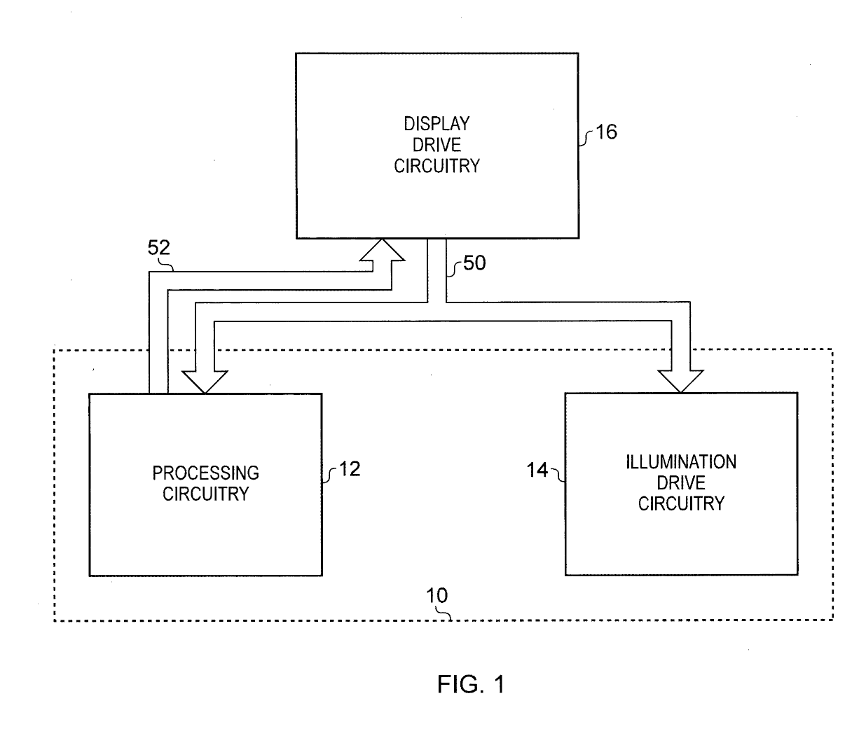

FIG. 1 illustrates display drive circuitry and an apparatus comprising processing circuitry and illumination drive circuitry;

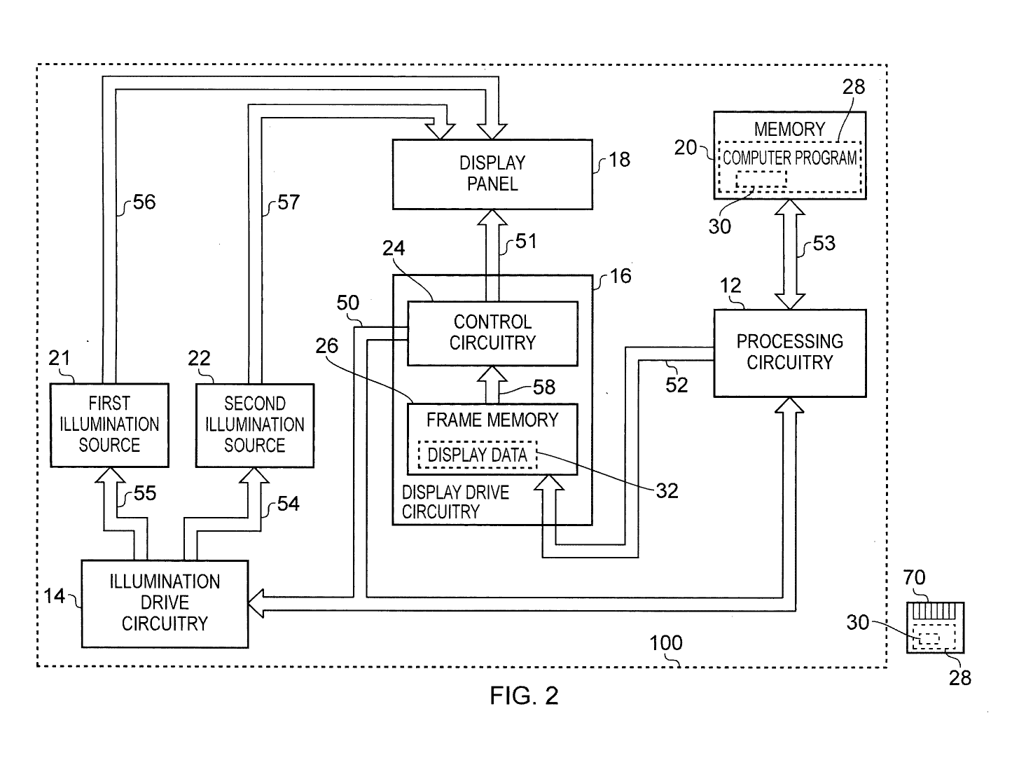

FIG. 2 illustrates a further apparatus comprising the display drive circuitry and the apparatus illustrated in FIG. 1;

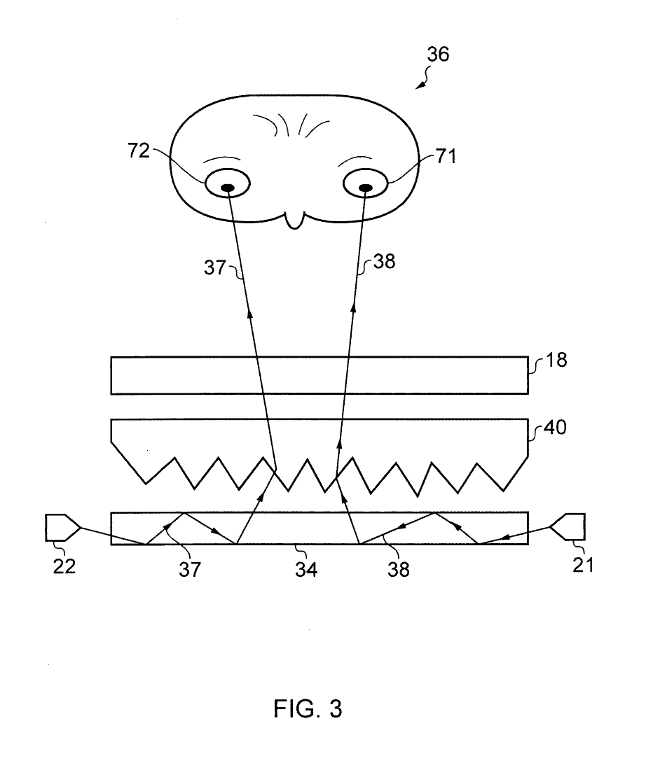

FIG. 3 illustrates a viewer viewing an auto-stereoscopic display;

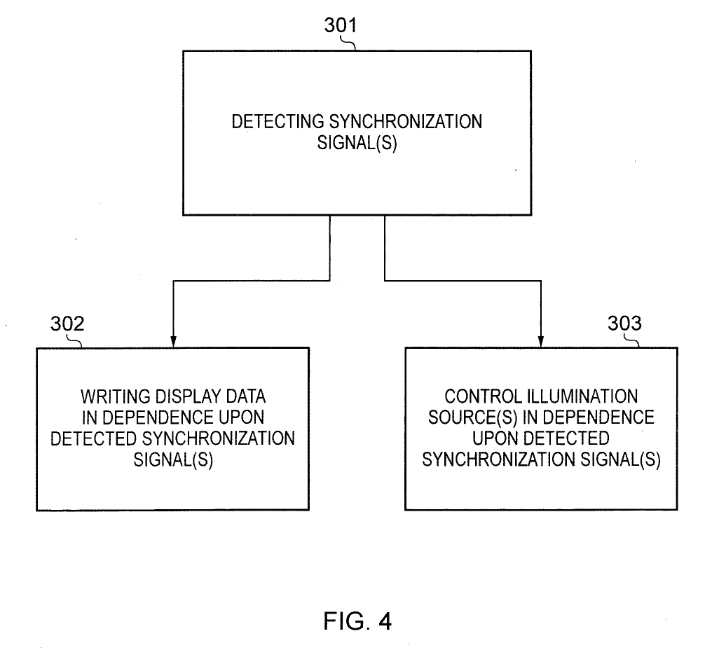

FIG. 4 illustrates a flow chart of a method;

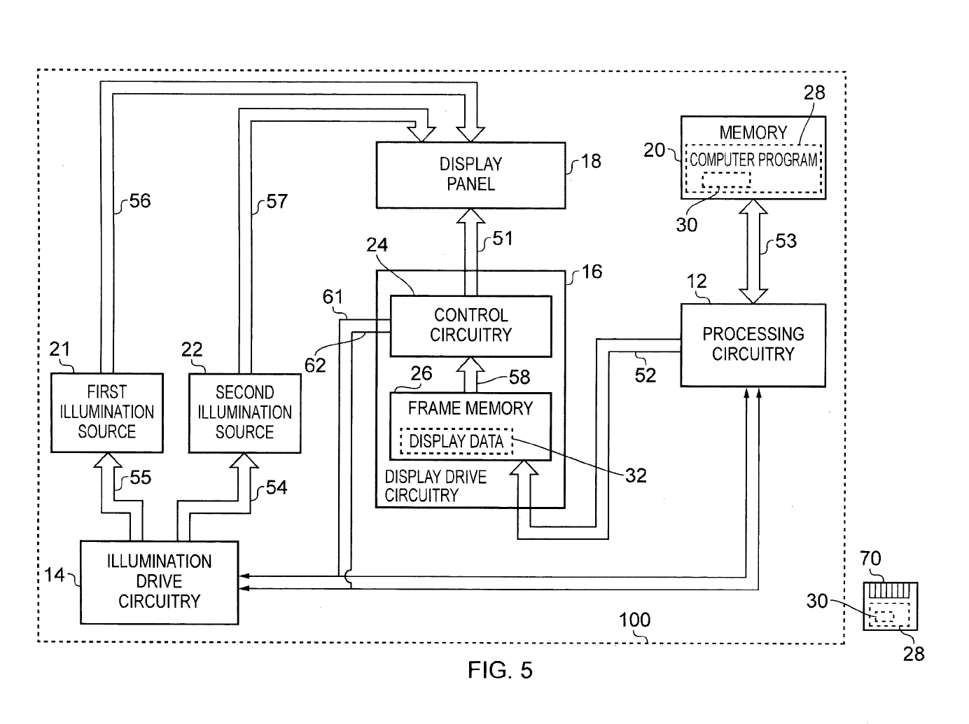

FIG. 5 illustrates a first implementation of the apparatus illustrated in FIG. 2;

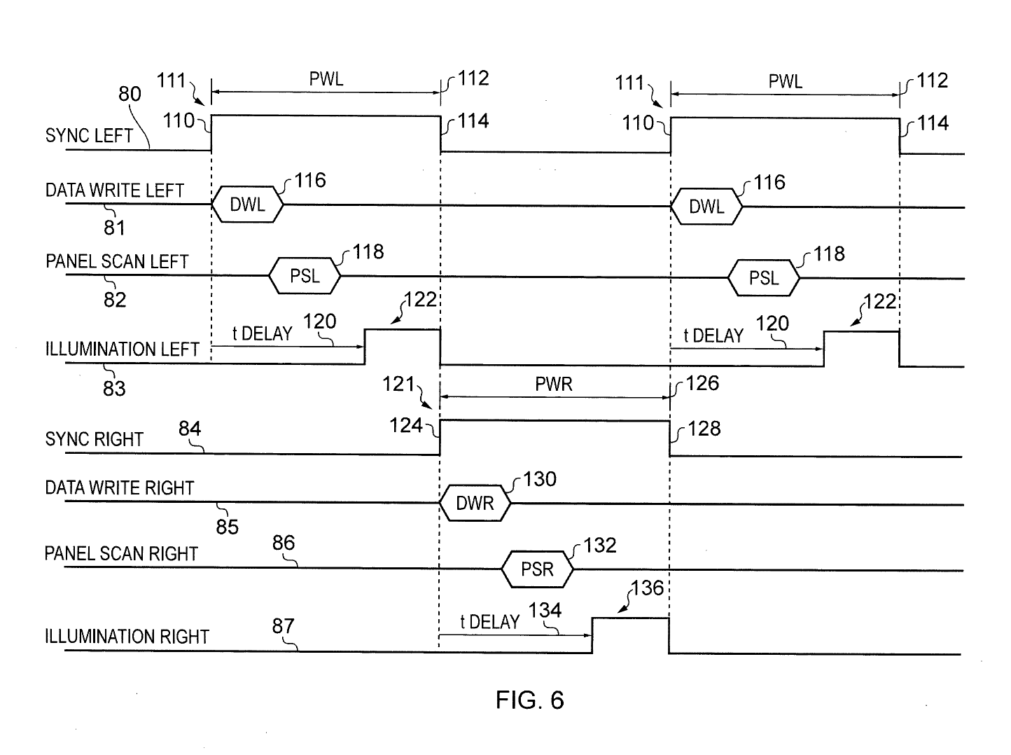

FIG. 6 illustrates a schematic depicting a method relating to the operation of the apparatus illustrated in FIG. 5;

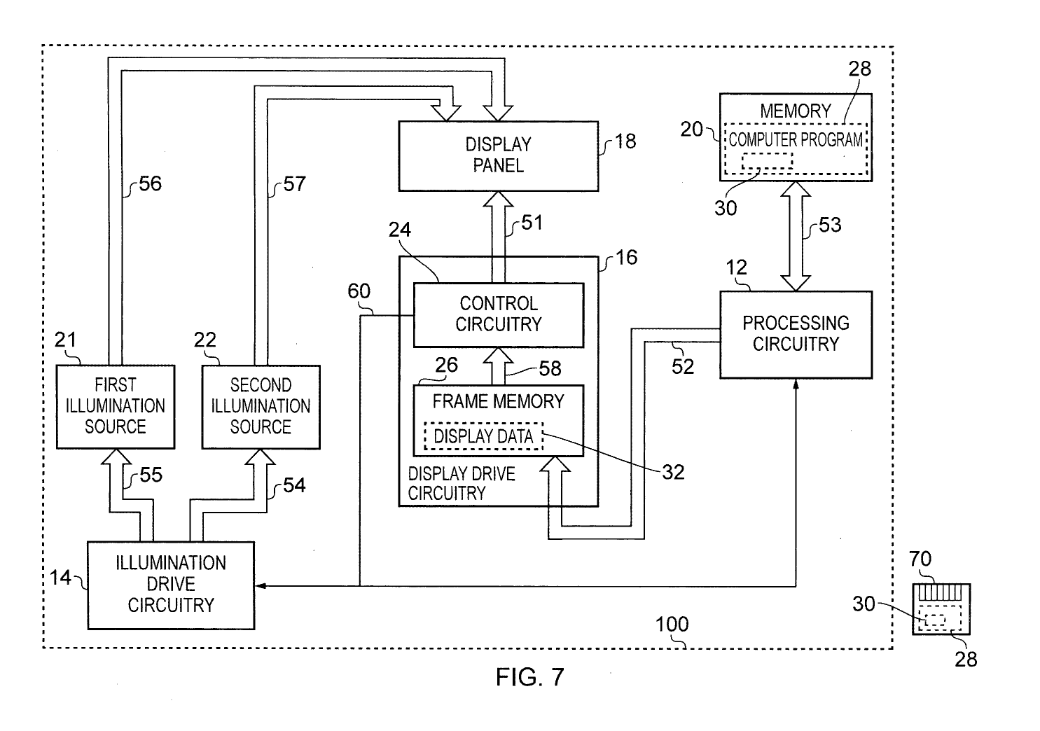

FIG. 7 illustrates a second implementation of the apparatus illustrated in FIG. 2; and

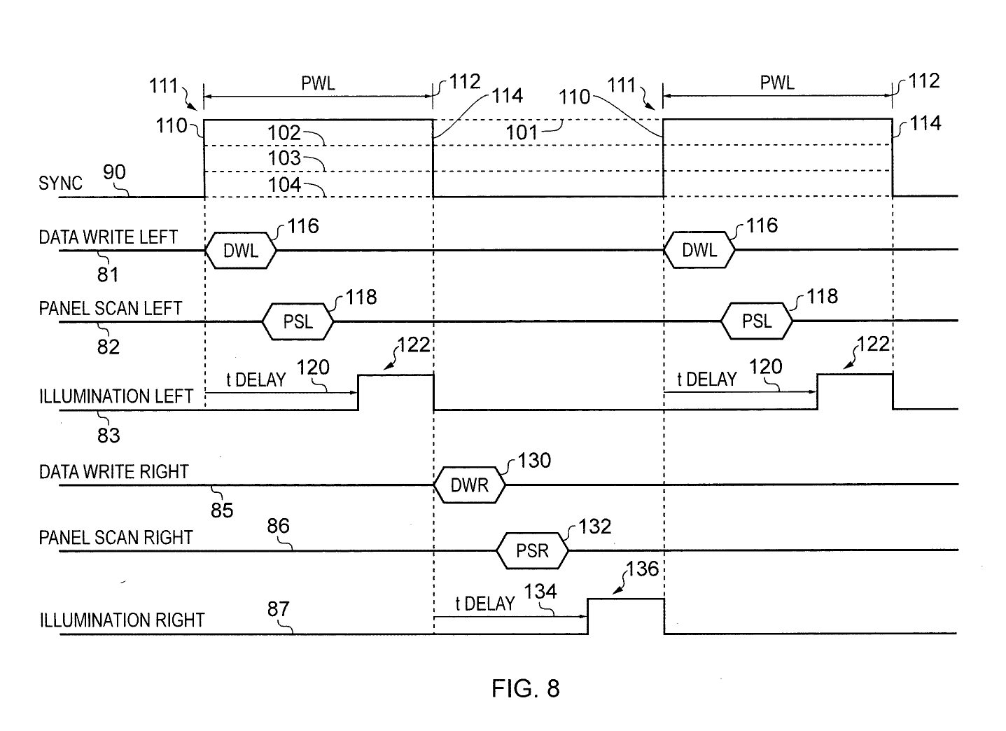

FIG. 8 illustrates a schematic depicting a method relating to the operation of the apparatus illustrated in FIG. 7.

### DETAILED DESCRIPTION

Embodiments of the invention relate to controlling the refresh and illumination of an auto-stereoscopic display. In particular, they relate to controlling the refresh and illumination of an auto-stereoscopic display which uses at least one illumination source to alternate between providing left and right images to the viewer's left and right eyes over time. For example, the auto-stereoscopic display may alternate between providing the left and right images so quickly that the viewer perceives that he is viewing the left and right images at the same time.

The Figures illustrate an apparatus 10/100, comprising: processing circuitry 12 configured to detect at least one synchronization signal 80, 84, 90 provided by display drive circuitry 16, and configured to write display data 32 to at least one frame memory 26 in dependence upon the at least one synchronization signal 80, 84, 90 detected at the processing circuitry 12; and illumination drive circuitry 14 configured to detect the at least one synchronization signal 80, 84, 90 provided by the display drive circuitry 16, and configured to control at least one illumination source 21, 22, in dependence upon the at least one synchronization signal 80, 84, 90 detected at the illumination drive circuitry 14.

FIG. 1 illustrates an apparatus 10 and display drive circuitry 16. The apparatus 10 may, for example, be one or more chip-sets and comprises processing circuitry 12 and illumination drive circuitry 14. The elements 12, 14 and 16 are operationally coupled and any number or combination of intervening elements can exist (including no intervening elements).

The processing circuitry 12 may comprise one or more processors. The processing circuitry 12 may, for example, comprise a central processing unit (CPU) and/or one or more graphics processing units (GPUs).

The processing circuitry 12 and the illumination drive circuitry 14 are configured to detect outputs provided by display drive circuitry 16, as indicated by the arrow 50. In particular, the processing circuitry 12 and the illumination drive circuitry 14 are configured to detect one or more synchronization signals provided by the display drive circuitry 16.

The processing circuitry 12 is configured to write display data 32 to at least one frame memory 26 of the display drive circuitry 16, in dependence upon the one or more synchronization signals detected at the processing circuitry 12. This is illustrated schematically in FIG. 1 by the arrow 52.

The illumination drive circuitry 14 is configured to drive one or more illumination sources. The one or more illumination sources may, for example, be driven to cause an auto-stereoscopic image to be conveyed to a viewer.

In particular, the illumination drive circuitry 14 is configured to control at least one illumination source, in dependence upon the one or more synchronization signals detected at the illumination drive circuitry 14.

FIG. 2 illustrates an apparatus 100. The apparatus 100 may, for example, be a hand portable electronic device such as a mobile telephone, a tablet computer, a music player or a hand-held games console.

The apparatus 100 comprises the display drive circuitry 16 and the apparatus 10 illustrated in FIG. 1, along with a display panel 18, a memory 20 and a plurality of illumination sources 21, 22. The elements 12, 14, 16, 18, 20, 21 and 22 are operationally coupled and any number or combination of intervening elements can exist (including no intervening elements).

In the example illustrated in FIG. 2, the processing circuitry 12 is configured to read from and write to the memory 20, as indicated by the arrow 53. The memory 20 stores a computer program 28 comprising computer program instructions 30 that at least partially control the operation of the apparatus 100 when loaded into the processing circuitry 12.

The computer program instructions 30 may provide logic and routines that enables the apparatus 100 to perform the methods illustrated in FIGS. 4, 6 and 8. The processing circuitry 12, by reading the memory 20, is able to load and execute the computer program 28.

The computer program 28 may arrive at the apparatus 100 via any suitable delivery mechanism 70. The delivery mechanism 70 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 28. The delivery mechanism may be a signal configured to reliably transfer the computer program 28. The apparatus 100 may propagate or transmit the computer program 28 as a computer data signal.

Although the memory 20 is illustrated as a single component it may be implemented as one or more separate components some or all of which may be integrated/removable and/or may provide permanent/semi-permanent/dynamic/cached storage.

In the FIG. 2 example, the display drive circuitry 16 comprises control circuitry 24 and at least one frame memory 26. The processing circuitry 12 is configured to generate display data 32, in the form of image frames, and write them to the frame memory 26. The writing of display data 32 to the frame memory 26 is illustrated by the arrow 52 in FIG. 2.

The control circuitry 24 is configured to control the display panel 18 using the stored display data 32. For example, the control circuitry 24 may be configured to retrieve a stored image frame and control the display panel 18 to display the stored image frame. This process is sometimes known as a “panel scan” or a “panel read”. The arrow 58 in FIG. 2 illustrates stored display data 32 being retrieved from the frame memory 26 by the control circuitry 24. The arrow 51 illustrates the control circuitry 24 controlling the display panel 18.

In the embodiments of the invention illustrated in FIG. 2, the display panel 18 is for displaying first and second images of an auto-stereoscopic image. The first, left, image is conveyed to a viewer's left eye, and the second, right, image is conveyed to a viewer's right eye. Only one of the left and right images is displayed on the display panel 18 at any one time. However, the display panel alternates between displaying the left image and displaying the right image so quickly that the viewer perceives the display panel 18 to be displaying the left and right images simultaneously and sees an auto-stereoscopic image.

In the illustrated example, the processing circuitry 12 is configured to write left and right image frames of auto-stereoscopic images to different memory spaces in the frame memory 26. However, in some alternative embodiments of the invention, physically separate frame memories are provided to store left and right image frames.

The control circuitry 24 is configured to determine when a complete image frame has been retrieved from the display data 32 of the frame memory 26, and used to display an image frame on the display. The control circuitry 24 responds by providing at least one synchronization signal to the illumination drive circuitry 14 and the processing circuitry 12. This is illustrated by the arrows 50 in FIG. 2.

For example, consider a display having a particular resolution, such as 800×480 (WVGA; Wide Video Graphics Array). An image frame comprises 800 vertical lines and 480 horizontal lines. In some embodiments, the control circuitry 24 updates the image frame displayed on the display panel 18 a horizontal line at a time, using the display data 32 stored in the frame memory 26. The control circuitry 24 is configured to determine when the final horizontal line has been updated for a particular frame (in this example the 480^{th} line) and respond by indicating this using one or more synchronization signals provided to the illumination drive circuitry 14 and the processing circuitry 12.

In circumstances where the display panel 18 is being used to convey an auto-stereoscopic image to a viewer, the control circuitry 24 may be configured to indicate, using the synchronization signal(s), when it has completed controlling the display panel 18 to display a left image frame, and when it has completed controlling the display panel 18 to display a right image frame.

The processing circuitry 12 is configured to detect the one or more synchronization signals output by the control circuitry 24. The processing circuitry 12 writes display data to the frame memory 26 in dependence upon the detected one or more synchronization signals. It uses the one or more synchronization signals to determine when to write display data 32 to the frame memory 26.

For example, the processing circuitry 12 may respond to an indication that the control circuitry 24 has completed controlling the display panel 18 to display an image frame by writing further display data 32, corresponding with a new image frame, to the frame memory 26.

If a synchronization signal indicates, for instance, that the control circuitry 24 has completed controlling the display panel 18 to display a left image frame, the processing circuitry 12 responds by writing display data 32, corresponding with a new left image frame, to the frame memory 26. Similarly, if a synchronization signal indicates that the control circuitry 24 has completed controlling the display panel 18 to display a right image frame, the processing circuitry 12 responds by writing display data 32, corresponding with a new right image frame, to the frame memory 26.

The illumination drive circuitry 14 is configured to detect the one or more synchronization signals output by the control circuitry 24. The illumination drive circuitry 14 controls one or more illumination sources 21, 22 in dependence upon the detected one or more synchronization signals.

Each illumination source 21, 22 may, for example, comprise one or more light emitting diodes (LEDs), one or more electroluminescent panels, and/or one or more fluorescent lamps.

In the example illustrated in FIG. 2, the apparatus 100 comprises first and second illumination sources 21, 22. If the one or more synchronization signals indicate that the control circuitry 24 has completed controlling the display panel 18 to display a left image frame, the illumination drive circuitry 14 responds by driving the first illumination source 14. This is illustrated by the arrow 55 in FIG. 2. The first illumination source 21 responds by producing light (illustrated by arrow 56), causing the left image frame displayed on the display panel 18 to be conveyed to the viewer.

If the one or more synchronization signals indicate that the control circuitry 24 has completed controlling the display panel 18 to display a right image frame, the illumination drive circuitry 14 responds by driving the second illumination source 22. This is illustrated by the arrow 54 in FIG. 2. The second illumination source 22 responds by producing light (illustrated by arrow 57), causing the right image frame displayed on the display panel 18 to be conveyed to the viewer.

FIG. 3 illustrates an auto-stereoscopic image being conveyed to a viewer 36. In the illustration, an optical arrangement including a light guide 34 and a grating 40 are used to convey light from the illumination sources 21, 22 towards the viewer 36.

The first illumination source 21 produces light 38 that is directed by the optical arrangement 34, 40 through the display panel 18 and towards the viewer's left eye 71. If a left image frame is displayed on the display panel 18, it is conveyed towards the viewer's left eye 71 (but not the viewer's right eye 72).

The second illumination source 22 produces light 37 that is directed by the optical arrangement 34, 40 through the display panel 18 and towards the viewer's right eye 72. If a right image frame is displayed on the display panel 18, it is conveyed towards the viewer's right eye 72 (but not the viewer's left eye 71).

The illumination drive circuitry 14 is configured to switch between driving the first illumination source 21 and driving the second illumination source 22 in dependence upon the synchronization signals provided by the control circuitry 24. The switching occurs at a rate that causes the viewer 36 to perceive that he is viewing the right and left image frames simultaneously. The viewer 36 therefore views an auto-stereoscopic image.

FIG. 4 illustrates a method according to embodiments of the invention. At block 301 of FIG. 4, the display drive circuitry 16 provides at least one synchronization signal, which is detected by the processing circuitry 12 and the illumination drive circuitry 14.

At block 302 of FIG. 4, the processing circuitry 12 writes display data, such as one or more image frames, to the frame memory 26 in dependence upon the detected synchronization signal(s).

At block 303 of FIG. 4, the illumination drive circuitry 14 controls one or more illumination sources 21, 22 in dependence upon the detected synchronization signal(s).

FIG. 5 illustrates an implementation of the invention in which the control circuitry 24 of the display drive circuitry 16 provides first and second synchronization signals to both the processing circuitry 12 and the illumination drive circuitry 14. The first and second synchronization signals are electrical signals that are set on separate signal lines. Each signal line extends from the display drive circuitry 16 to the processing circuitry 12 and to the illumination drive circuitry 14. This is illustrated in FIG. 5 by the arrows labelled with the reference numerals 61 and 62.

FIG. 6 illustrates a method of operation of the apparatus 100 illustrated in FIG. 5. The first/left synchronization signal 80 provided by the control circuitry 24 of the display drive circuitry 16 is indicated by the text “SYNC LEFT”. The first/left synchronization signal 80 includes a series of pulses 111. Each pulse 111 comprises a rising edge 110 and a falling edge 114. The width of the pulses is indicated by reference numeral 112 and labelled “PWL” (Pulse Width Left).

The text “Data Write Left” and the reference numeral 81 indicate a portion of FIG. 6 that relates to the processing circuitry 12 writing data to the frame memory 26. In these embodiments of the invention, the processing circuitry 12 is configured to use at least one property of the first/left synchronization signal 80 to determine when to write display data 32 to the frame memory 26. In the illustrated example, the property used by the processing circuitry 12 is the rising edge 110 of a pulse 111 in the first/left synchronization signal 80. The processing circuitry 12 responds to detection of the rising edge 110 by writing display data 32, in the form of a left image frame, to the frame memory 26. The process of writing the left image frame is indicated schematically by block 116 in FIG. 6.

The control circuitry 24 begins to control the display panel 18 to display the left image frame after the processing circuitry 12 has begun to write the left image frame to the frame memory 26. The text “PANEL SCAN LEFT” and the reference numeral 82 indicate the portion of FIG. 6 that relates to the control circuitry 24 controlling the display panel 18 to display left image frames. The block 118 indicates the control circuitry 24 controlling the display panel 18 to display the left image frame that is being written/was written to the frame memory 26 by the processing circuitry 12 at block 116.

It can be seen from FIG. 6 that the actions performed by the control circuitry 24 in controlling the display of the left image frame lag the actions of the processing circuitry 12 in writing of the left image frame to the frame memory 26. That is, the control circuitry 24 begins to retrieve the left image frame from the frame memory 26 after the processing circuitry 12 has begun to write the left image frame to the frame memory 26.

The control circuitry 24 may retrieve the constituent parts of the left image frame from the frame memory 26 in the order in which they were written to the frame memory 26 by the processing circuitry 12. For instance, consider an example in which the left image frame comprises 480 horizontal lines. In this example, the processing circuitry 12 may write the 1^{st} line, followed by the 2^{nd} line, followed by the 3^{rd} line, etc. The control circuitry 24 begins to retrieve each line of the left image frame in the same order as it was written to the frame memory 26. The retrieval of the left data frame from the frame memory 26 may be slower than or at the same speed as the data writing process, so that that it does not “catch up” with the writing of the left image frame to the frame memory 26.

The text “ILLUMINATION LEFT” and the reference numeral 83 indicate the drive signal provided by the illumination drive circuitry 14 to control the first illumination source 21 to produce light. The illumination drive circuitry 14 is configured to use one or more properties of the first/left synchronization signal 80 to control the first illumination source 21. In this example, the illumination drive circuitry 14 uses the rising edge 110 of a pulse 111 in the first/left synchronization signal 80 to determine when to control the first illumination source 21 to produce light.

A rising edge 110 of a pulse 111 in the first/left synchronization signal 80 therefore triggers both the writing of a left image frame to the frame memory 26 and the activation of the first illumination source 21.

In the illustrated embodiment of the invention, there is a time delay (tDELAY) 120 between a rising edge 110 of a pulse 111 in the first/left synchronization signal 80 being detected by the illumination drive circuitry 14, and the illumination drive circuitry 14 controlling the first illumination source 21 to produce light. In this example, the time delay 120 is such that the illumination drive circuitry 14 begins to control the first illumination source 21 to produce light (by providing pulse 122) after the control circuitry 24 has retrieved the whole of the left image frame from the frame memory 26 and displayed it on the display panel 18. When the first illumination source 21 produces light, the left image frame is conveyed to the left eye of a viewer, as described above in relation to FIG. 3.

When the illumination drive circuitry 14 detects the falling edge 114 of a pulse 111 in the first/left synchronization signal 80, it ceases to drive the first illumination source 21 and the left image frame is no longer conveyed to the viewer. The duration of time over which the illumination drive circuitry 14 drives the first illumination source 21 therefore depends upon the width 112 of the pulses 111 in the first/left synchronization signal 80.

The second/right synchronization signal 84 provided by the control circuitry 24 of the display drive circuitry 16 is indicated by the text “SYNC RIGHT”. The second/right synchronization signal 84 includes a series of pulses 121. Each pulse 121 comprises a rising edge 124 and a falling edge 128. The width of the pulses 121 is indicated by reference numeral 126 and labelled “PWR” (Pulse Width Right). In this example, the rising edge 124 of the second/right synchronization signal 84 is provided at substantially the same time as the falling edge 114 of the first/left synchronization signal 80.

The text “Data Write Right” and the reference numeral 85 indicate a portion of FIG. 6 that relates to the processing circuitry 12 writing data to the frame memory 26. The processing circuitry 12 is configured to use at least one property of the second/right synchronization signal 84 to determine when to write display data 32 to the frame memory 26. In the illustrated example, the property used by the processing circuitry 12 is the rising edge 124 of a pulse 121 in the second/right synchronization signal 84. The processing circuitry 12 responds to detection of the rising edge 124 by writing display data 32, in the form of a right image frame, to the frame memory 26. The process of writing the right image frame is indicated schematically by block 130 in FIG. 6.

The control circuitry 24 begins to control the display panel 18 to display the right image frame after the processing circuitry 12 has begun to write the right image frame to the frame memory 26. The text “PANEL SCAN RIGHT” and the reference numeral 86 indicate the portion of FIG. 6 that relates to the control circuitry 24 controlling the display panel 18 to display right image frames. The block 132 indicates the control circuitry 24 retrieving the right image frame from the frame memory 26 and controlling the display panel 18 to display it, causing the left image frame currently displayed on the display panel 18 to be replaced with the right image frame.

It can be seen from FIG. 6 that the actions performed by the control circuitry 24 in controlling the display of the right image frame lag the actions of the processing circuitry 12 in writing of the right image frame to the frame memory 26. That is, the control circuitry 24 begins to retrieve the right image frame from the frame memory 26 after the processing circuitry 12 has begun to write the right image frame to the frame memory 26.

The control circuitry 24 may retrieve the constituent parts of the right image frame from the frame memory 26 in the order in which they were written to the frame memory 26 by the processing circuitry 12. The retrieval of the right data frame from the frame memory 26 may be slower than or at the same speed as the data writing process, so that that it does not “catch up” with the writing of the right image frame to the frame memory 26.

The text “ILLUMINATION RIGHT” and the reference numeral 87 indicate the drive signal provided by the illumination drive circuitry 14 to control the second illumination source 22 to produce light. The illumination drive circuitry 14 is configured to use one or more properties of the second/right synchronization signal 84 to control the second illumination source 22. In this example, the illumination drive circuitry 14 uses the rising edge 124 of a pulse 121 in the second/right synchronization signal 84 to determine when to control the second illumination source 22 to produce light.

A rising edge 124 of a pulse 121 in the second/right synchronization signal 84 therefore triggers both the writing of a right image frame to the frame memory 26 and the activation of the second illumination source 22.

In the illustrated embodiment of the invention, there is a time delay (tDELAY) 134 between a rising edge 124 of a pulse 121 in the second/right synchronization signal 84 being detected by the illumination drive circuitry 14, and the illumination drive circuitry 14 controlling the second illumination source 22 to produce light. In this example, the time delay 134 is such that the illumination drive circuitry 14 begins to control the second illumination source 22 to produce light (by providing pulse 136) after the control circuitry 24 has retrieved the whole of the right image frame from the frame memory 26 and displayed it on the display panel 18. When the second illumination source 22 produces light, the right image frame is conveyed to the right eye of a viewer, as described above in relation to FIG. 3.

When the illumination drive circuitry 14 detects the falling edge 128 of a pulse 121, it ceases to drive the second illumination source 22 and the right image frame is no longer conveyed to the viewer. The duration of time over which the illumination drive circuitry 14 drives the second illumination source 22 depends upon the width 126 of the pulses 121 in the second/right synchronization signal 84.

A rising edge 111 in the first/left synchronization signal 80 is provided at substantially the same time as the falling edge 128 of the second/right synchronization signal 84, and the process described above is repeated for the writing and display of new left and right image frames. FIG. 6 illustrates a further left image frame being written to the frame memory 26 and displayed on the display panel 18.

In the embodiments of the invention described above, the writing of left and right image frames to the frame memory 26 and the illumination of the display panel 18 is synchronized by the first and second synchronization signals 80, 84. The same synchronization signal 80, 84 is used to synchronize the writing of a particular image frame to the frame memory 26 and the illumination of the display panel 18 when that image frame is displayed. Advantageously, this means that only two signal lines (one for each synchronization signal) need be provided.

The time delays 120, 134 in detecting the synchronization signals 80, 84 and illuminating the display panel 18 advantageously result in a clearer auto-stereoscopic image. This is because, in the illustrated example, the display panel 18 is illuminated after the panel scanning process 118 for a particular image frame has been completed.

If the display panel 18 were illuminated before the panel scanning process 118 had been completed, the part of the new image frame and part of the previous image frame would be conveyed to the viewer, resulting in “cross-talk”. The proportion of the new and previous image frames that would be conveyed would depend upon when the display panel 18 were illuminated relative to the progress of the on-going panel scanning process 118.

In some embodiments of the invention, there is a smaller time delay 120,134 or no time delay 120, 134 between the detection of the synchronization signal 80, 84 and the driving of the relevant illumination source 21, 22. This increases the perceived brightness of the display panel 18, but also the perceived cross-talk.

The time delay 120, 134 between the between the detection of the synchronization signal 80, 84 may be viewer selectable. For example, the viewer may be able to select from a plurality of options ranging from high brightness (but high cross talk) to low brightness (and low cross talk).

In some implementations of the invention, a property of the synchronization signals 80, 84 may be used to control the viewer-perceived brightness of the display panel 18. For instance, the amplitude or the width of the pulses 111, 121 in the synchronization signals 80, 84 may be used to control the brightness. The illumination drive circuitry 14 may control the intensity of light that is output by an illumination source 21, 22 in dependence upon the amplitude of the pulses 111, 121 in the relevant synchronization signal 80, 84. Alternatively or additionally, the illumination drive circuitry 14 may control the duration of time that light is output by an illumination source 21, 22 in dependence upon the width of pulses 111, 121 in the relevant synchronization signal 80, 84. The longer the display panel 18 is illuminated for, the higher the viewer-perceived brightness of the display panel 18.

In these implementations, the brightness of the display may be viewer selectable. The selection of an increased brightness level by the viewer would result in pulses 111, 121 of a greater amplitude and/or greater width being provided in the synchronization signals 80, 84.

FIG. 7 illustrates an implementation of the invention in which the control circuitry 24 of the display drive circuitry 16 provides a single synchronization signal to both the processing circuitry 12 and the illumination drive circuitry 14. The synchronization signal is set on a signal line that extends from the display drive circuitry 16 to the processing circuitry 12 and the illumination drive circuitry 14. This is illustrated in FIG. 7 by the arrows labelled with the reference numeral 60.

FIG. 8 illustrates a method of operation of the apparatus 100 illustrated in FIG. 7. The method of operation illustrated in FIG. 7 is similar to that described in relation to FIG. 6, except that control circuitry 24 provides a single synchronization signal 90 to control the writing of display data 32 to the frame memory 26 and the illumination of the display panel 18.

In the FIG. 8 example, a rising edge 110 the synchronization signal 90 causes the processing circuitry 12 to write display data 32, in the form of left image frame, to the frame memory 26. The rising edge 110 is also used as the trigger for the illumination drive circuitry 14 to drive the first illumination source 21, in order to cause the left image frame to be conveyed to the viewer.

A falling edge 114 in the synchronization signal 90 causes the processing circuitry 12 to write display data 32, in the form of a right image frame, to the frame memory 32. The falling edge 114 is also is also used as the trigger or the illumination drive circuitry 14 to drive the second illumination source 22, in order to cause the right image frame to be conveyed to the viewer.

In the embodiments of the invention illustrated in FIGS. 7 and 8, the amplitude of a pulse 111 in the synchronization signal 90 may be used to control the brightness of the display panel 18. For example, if the amplitude of a pulse 111 rises to the level indicated by the dotted line 102, it may indicate a first intensity level for the first illumination source 21 (for example, a minimum intensity level). Alternatively, if the amplitude of a pulse 111 rises to the level indicated by the dotted line 101, it may indicate a second intensity level for the first illumination source 21 (for example, a maximum intensity level).

If the amplitude of a pulse 111 falls to the level indicated by the dotted line 103, it may indicate a first intensity level for the second illumination source 22 (for example, a minimum intensity level). If the amplitude of a pulse 111 falls the level indicated by the dotted line 104 (substantially zero in FIG. 8), it may indicate a second intensity level for the second illumination source 22 (for example, a maximum intensity level).

In the embodiments of the invention described above in relation to FIGS. 7 and 8, a single synchronization signal 90 is used to synchronize the writing of image frames to the frame memory 26 and the illumination of the display panel 18. Advantageously, only a single signal line need be provided for this purpose.

References to ‘computer-readable storage medium’, ‘computer program product’, ‘tangibly embodied computer program’ etc. or a ‘controller’, ‘computer’, ‘processor’, ‘processing circuitry’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The blocks illustrated in FIGS. 4, 6 and 8 may represent steps in a method and/or sections of code in the computer program 28. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example, a display panel 18 having a WVGA resolution (800×480) is mentioned above. However, those skilled in the art will recognize that embodiments of the invention are applicable to display panels having any resolution.

The apparatus 100 is described as comprising two different illumination sources 21, 22. In some embodiments of the invention, only a single illumination source is provided. A time-varying optical arrangement may be used to alter the optical path of light provided by the single illumination source, to enable it to provide light alternatively to a viewer's left and right eyes (causing an auto-stereoscopic image to be conveyed to the viewer).

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
detecting, at processing circuitry and illumination drive circuitry, at least one synchronization signal provided by display drive circuitry;
writing display data to at least one frame memory using the processing circuitry, in dependence upon the at least one synchronization signal detected at the processing circuitry; and
controlling at least one illumination source using the illumination drive circuitry, in dependence upon the at least one synchronization signal detected at the illumination drive circuitry.

2. A method as claimed in claim 1, wherein the illumination drive circuitry controls the at least one illumination source to cause an auto-stereoscopic image to be conveyed to a viewer.

3. A method as claimed in claim 2, wherein the illumination drive circuitry alternates between driving two different illumination sources, in order to cause the auto-stereoscopic image to be conveyed to the viewer.

4. A method as claimed in claim 1, wherein at least one property of the at least one synchronization signal is used by the processing circuitry to determine when to write display data to the at least one frame memory.

5. A method as claimed in claim 4, wherein at least one property of the at least one synchronization signal is used by the illumination drive circuitry to determine when to drive the at least one illumination source.

6. A method as claimed in claim 5, wherein the processing circuitry uses the same at least one property of the at least one synchronization signal to determine when the write the display data to the at least one frame memory, as the illumination drive circuitry uses to determine when to drive the at least one illumination source.

7. A method as claimed in claim 6, wherein the at least one property is the edge of pulses in the at least one synchronization signal.

8. A method as claimed in claim 1, wherein the durations of time over which the illumination drive circuitry drives each illumination source to produce light depends upon at least one property of the at least one synchronization signal.

9. A method as claimed in claim 8, wherein the at least property of the synchronization signal is the width of pulses in the at least one synchronization signal.

10. A method as claimed in claim 1, wherein the intensity of light provided by the at least one illumination source depends upon at least one property of the synchronization signal.

11. A method as claimed in claim 10, wherein the property is the amplitude of pulses of the at least one synchronization signal.

12. A method as claimed in claim 1, wherein the at least one synchronization signal is a single synchronization signal.

13. A method as claimed in claim 1, wherein the at least one synchronization is a plurality of synchronization signals, and each of the synchronization signals is detected at both the processing circuitry and the illumination drive circuitry.

14. A computer program comprising computer program instructions that, when executed by the processing circuitry, enable the method as claimed in claim 1 to be performed.

15. A non-transitory computer readable storage medium storing the computer program instructions as claimed in claim 14.

16. An apparatus, comprising
processing circuitry configured to detect at least one synchronization signal provided by display drive circuitry, and configured to write display data to at least one frame memory in dependence upon the at least one synchronization signal detected at the processing circuitry; and
illumination drive circuitry configured to detect the at least one synchronization signal provided by the display drive circuitry, and configured to control at least one illumination source, in dependence upon the at least one synchronization signal detected at the illumination drive circuitry.

17. An apparatus as claimed in claim 16, wherein the illumination drive circuitry is configured to control the at least one illumination source to cause an auto-stereoscopic image to be conveyed to a viewer.

18. An apparatus as claimed in claim 17, wherein the illumination drive circuitry is configured to alternates between driving two different illumination sources, in order to cause the auto-stereoscopic image to be conveyed to the viewer.

19. An apparatus as claimed in claim 16, wherein the processing circuitry is configured to use at least one property of the at least one synchronization signal to determine when to write display data to the at least one frame memory.

20. An apparatus as claimed in claim 19, wherein the illumination drive circuitry is configured to use at least one property of the at least one synchronization signal to determine when to drive the at least one illumination source.

21. An apparatus as claimed in claim 20, wherein the processing circuitry and the illumination drive circuitry are configured to use the same at least one property of the at least one synchronization signal.

22. An apparatus as claimed in claim 21, wherein the at least one property is the edge of pulses in the at least one synchronization signal.

23. An apparatus as claimed in claim 16, the illumination drive circuitry is configured to drive the illumination source to produce light over durations of time that depend upon at least one property of the at least one synchronization signal.

24. An apparatus as claimed in claim 23, wherein the at least property of the synchronization signal is the width of pulses in the at least one synchronization signal.

25. An apparatus as claimed in claim 16, wherein the intensity of light provided by the at least one illumination source depends upon at least one property of the synchronization signal.

26. An apparatus as claimed in claim 25, wherein the property is the amplitude of pulses of the at least one synchronization signal.

27. An apparatus as claimed in claim 16, wherein the at least one synchronization signal is a single synchronization signal.

28. An apparatus as claimed in claim 16, wherein the at least one synchronization is a plurality of synchronization signals, the processing circuitry is configured to detect each of the synchronization signals, and the illumination drive circuitry is configured to detect each of the synchronization signals.

29. An apparatus, comprising:
processing means for detecting at least one synchronization signal provided by display drive means, and for writing display data to at least one frame memory in dependence upon the at least one synchronization signal detected at the processing means; and
illumination drive means for detecting the at least one synchronization signal provided by the display drive means, and for controlling at least one illumination source, in dependence upon the at least one synchronization signal detected at the illumination drive means.

30. An apparatus as claimed in claim 29, wherein the illumination drive means is for controlling the at least one illumination source to cause an auto-stereoscopic image to be conveyed to a viewer.

31. A computer program comprising computer program instructions that, when executed by processing circuitry, enable at least the following to be performed:
detecting, at the processing circuitry and illumination drive circuitry, at least one synchronization signal provided by display drive circuitry;
writing display data to at least one frame memory using the processing circuitry, in dependence upon the at least one synchronization signal detected at the processing circuitry; and
controlling at least one illumination source using the illumination drive circuitry, in dependence upon the at least one synchronization signal detected at the illumination drive circuitry.

32. A computer program as claimed in claim 31, wherein the illumination drive circuitry controls the at least one illumination source to cause an auto- stereoscopic image to be conveyed to a viewer.

33. A computer program as claimed in claim 32, wherein the illumination drive circuitry alternates between driving two different illumination sources, in order to cause the auto-stereoscopic image to be conveyed to the viewer.

34. A non-transitory computer readable storage medium storing the computer program as claimed in claim 31.
